(19) United States
(12) Patent Application Publication
(10) Pub. No.: US 2017/0201789 A1
(43) Pub. Date: Jul. 13, 2017

(54) METHOD TO CUSTOMIZE A SCREEN APPEARANCE OF A TELEVISION (TV) SET

(71) Applicants: Michael Mutchnik, Montreal (CA); Andrey Mutchnik, Montreal (CA)

(72) Inventors: Michael Mutchnik, Montreal (CA); Andrey Mutchnik, Montreal (CA)

(73) Assignee: MICHAEL MUTCHNIK, Montreal (CA)

(21) Appl. No.: 14/992,083

(22) Filed: Jan. 11, 2016

(51) Int. Cl. H04N 21/431; G06F 3/0482; H04N 21/45; H04N 21/2543; H04N 21/81

(52) U.S. Cl. CPC H04N 21/4312; H04N 21/2543; H04N 21/8126; H04N 21/4532; G06F 3/0482

(57) ABSTRACT

A method to customize a screen of a television (TV) set as a decor-appearance via providing by a TV service provider at least one decor-channel with at least one decor-appearance, offering the decor-channel to the user, allowing to the user an opportunity to choose the decor-appearance of the screen of the television (TV) set according to a personal preference of a user. The decor-channel could be transmitted as a product, according to a contract between the user and the TV service provider, or as a free of charge.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD

The present invention relates to a screen of a television (TV) set appearance, and more specifically to a new innovative method to customize a TV station screen as a decor-appearance being chosen from a decor-channel. The decor-channel, at least one, is transmitted by a TV service provider according to a contract between the user and the TV service provider, or as a free of charge decor-channel which is included in a service package proposed by the TV service provider.

### BACKGROUND OF THE INVENTION

Millions and millions television sets are made around the globe. Large gammas of different television sets (TVS) is an important part of the human life and are widely in use not only in a human residence, but in the public sector as well.

But what is happened when TV set is out of use? Typically its “looks” on us by its black screen. This “looks” is contrast and inconvenient in the entourage of a modern furniture and becomes even more distinctive in a beautiful pictures or arts surrounding.

As a prior art illustration, we refer to a Canadian application for patent CA2814263, priority 2012 May 22, describing a “Sliding panels system for hiding a flat screen TV”, which contains a sliding panels system for hiding a flat screen television, has a wall attachment panel, a pair of post members spaced from one another and attached to the wall attachment panel. This system is very bulky and need an additional space and need to be changed to adapt any changes of a decor.

US application for patent US20070211181, priority 2006 Mar. 9, is another prior art, describing a “Camouflaged display stand”. The stand conceals object, such as a television display, when one doesn't wish to observe that object, but otherwise exposes the object to view. It is also awkward and difficult adaptive to entourage.

Known US application for patent US20070211181, priority 2002 May 17, is describing a “Television screen saver”, which provide an opportunity to scan images into the Flash USB Drive and transfer or download those images into their television sets for use as a temporary screen saver. In this case a USB port needs to be installed to adopt the Flash USB drive. This invention is not universal and is difficult to be implemented in a vast variety of the television sets that not have the USB port.

It is also known US application for patent US200601816458, priority 2005 Nov. 14, describing a “TV and method of setting wallpaper or screen saver mode thereof” in which TV includes a user selection part; a plurality of image sources to store a playback image for the wallpaper or screen saver (WPSS) mode; and a controller to execute the WPSS mode when no broadcasting signal is detected. This invention cannot be implemented in a vast variety of existed television sets.

Thus, there exists a need to avoid all these inconvenient and to improve the “look” of diverse TV screens with a decorative appearance.

### OBJECTS OF THE INVENTION

It is an object of the present invention to improve at least some of the inconveniences existing in the prior art.

It is another object of the present invention to provide a new innovative method to customize a TV station screen as a decor-appearance being chosen according to a personal preference of a user from at least one decor-channel transmitted by TV service provider.

It is a further object of the present invention to integrate the screen of the TV station into a dwelling decor.

It is an additional object of the present invention to allow to the user an opportunity to choose the screen decor-appearance from the decor-channel and to adjust the screen of the TV station with at least one decor-appearance according to the personal preference of the user.

It is a next object of the present invention to allow the screen of the TV station adjustment with at least one decor-appearance according to the personal preference of the user.

It is an extra object of the present invention to create new decor-appearances of the TV station screen.

It is a more object of the present invention to create a favorite list of the decor-appearances of the TV station screen with a possibility to add or to remove the decor-appearances by the user or by the TV service provider.

Further objects and advantages of the invention will be in part obvious from an inspection of the accompanying drawings and a careful consideration of the following description.

### BRIEF SUMMARY OF THE INVENTION

To achieve above mentioned objects, the method to customize a screen appearance of a television (TV) set, described in the present specification of the invention, provides a user with the decor-appearance on the screen of the TV set according to a personal preference of the user.

The method comprises following: providing by a TV service provider at least one decor-channel, which includes at least one decor-appearance; offering the decor-channel to the user as a product; transmitting this at least one decor-channel to at least one TV station; allowing to the user an opportunity to choose the screen decor-appearance from the decor-channel; and providing the decor-appearance on the screen of the television (TV) set according to a personal preference of the user.

The decor-channel could be transmitted as the product according to a contract between the user and the TV service provider, or free of charge as a bonus or an additional product. The decor-channel may be included in a portfolio of different channels providing by the TV service provider, as well.

In the environment of the present invention, the decor-channel could be provided as a selected program during activation of the television (TV) set.

The invention permits, when the decor-channel includes at least one decor-collection, each decor-collection could contain at least two decor-appearances. In this embodiment the method comprise the step of allowing the user with an opportunity to choose the screen decor-appearance from the chosen decor-collection of the decor-channel and to adjust the screen of the TV station with at least one decor-appearance according to the personal preference of the user.

In the context of the present invention, the decor-appearances could be shifted by the TV service provider or by the user from the same or different decor-collections. The displayed decor-appearances can also be shifted in an adjust timeframe.

The method, according to the present invention, includes a possibility to produce the decor-appearances as at least one slideshow.

The decor-appearances on the screen of the television (TV) set may be accompanying by a personal preference of a user, such as music, sound, comment, remark, advertisement, news, broadcast, weather announcement, etc, or as some combination of them. It is understood that the user may have a possibility to accept or to refuse each or any of the accompanying.

As well the invention also permits to determine the decor-appearances, and to include or to remove them by the TV service provider into/of the decor-channel as a result from an identification of a selected decor-appearance, a wish list or a feedback of the user.

The decor-appearances could be determined and added/removed by the TV service provider into/of the decor-channel as a result of an attitude of the user. They could be added or removed by the user as well.

Next embodiment of the present invention includes a possibility that the decor-channel been provided with a menu, to allow selection and search options to choose the decor-appearances.

There is other possibility that the decor-appearances being displayed as a portion of the screen and could be zoomed and/or moved. The portion of the screen could be chosen by the user.

The decor-appearances could be displaying on the portion of the TV screen simultaneously to at least one another program proposed by the TV service provider.

The decor-appearances might be displaying on the portion of the TV screen simultaneously to another at least one program selected from a television (TV) set menu setup program.

The decor-channel could be displayed during activation of the TV set. Moreover, any decor-appearance chosen from the decor-channel could be displayed during activation of the TV set.

It is also possible that the decor-appearance chosen from the decor-channel being displayed when the TV set is on a television screen saver mode.

The invention allows fashioning the screen decor-appearances of the television (TV) set by the different decorative mode attractive to the user.

Embodiments each have at least one of the above-mentioned objects and/or aspects, but do not necessarily have all of them. It should be understood that some aspects of the present invention that have resulted from attempting to attain the above-mentioned objects may not satisfy one of objects and/or may satisfy other objects not specifically recited herein.

Additional and/or alternative features, objects, aspects and advantages of the present invention will become apparent from the following description and the appended claims.

### DETAILED DESCRIPTION OF THE INVENTION

The description that follows in this section is not an attempt at defining (and is not intended to define, limit or otherwise restrict) the scope of the present method, but simply to provide information related to the present method as an aid in its understanding.

The method to customize a screen appearance of a television (TV) set, according to a personal preference of a user comprises the steps of providing by a TV service provider at least one decor-channel; presenting at least one decor-appearance into the decor-channel; offering the decor-channel to the user as a product; transmitting this at least one decor-channel to at least one TV station, the decor-channel could be transmitted as the product according to a contract between the user and the TV service provider, or as a free of charge; allowing to the user an opportunity to choose the screen decor-appearance from the decor-channel, and customizing the decor-appearance of the television (TV) set screen according to a personal preference of the user.

The decor-channel could be included in a portfolio of different channels providing by the TV service provider. This decor-channel could be provided as a selected program during activation of the television (TV) set.

The decor-channel could include at least one decor-collection, each decor-collection may contain at least two decor-appearances, to allow to the user an opportunity to choose the screen decor-appearance from the chosen decor-collection of the decor-channel and to adjust the screen of the TV station with at least one decor-appearance according to the personal preference of the user.

The decor-appearance may be chosen from any of different area of human interests, as for instance art, travel, animals, technique, wallpaper décor, abstraction, etc., or any combination of them.

The decor-appearances may be shifted by the TV service provider or by the user from the same or a different decor-collection. The displayed decor-appearances could be shifted in an adjust timeframe.

Our invention also includes a possibility to produce the decor-appearances as at least one slideshow.

The decor-appearances on the screen of the television (TV) set could be accompanying by a personal preference of a user, such as music, sound, comment, remark, advertisement, news, broadcast, weather announcement, etc, or as any combination of them. They could be determined and included/removed by the TV service provider into/of the decor-channel as a result from an identification of a selected decor-appearance, a wish list or a feedback of the user.

In another embodiment of the method described in the present invention, the decor-appearances are determined and included/removed by the TV service provider into/of the decor-channel as a result of an attitude of the user. They moreover could be added or removed by the user or by the TV service provider according to a user wish.

The method, according to present invention, includes a possibility to provide the decor-channel with a menu, which allowing a selection and search option of decor-appearances.

The decor-appearances could be displayed as a portion of the screen with an option to be zoomed and/or moved. The portion of the screen is chosen by the user and may be displayed on the portion of the TV screen simultaneously to at least one another program proposed by the TV service provider.

The method further comprise the possibility that the decor-appearances be displayed on the portion of the TV screen simultaneously to another at least one program selected from a television (TV) set menu setup program.

In an additional embodiment of the method described in the present invention, the decor-channel may be displayed during activation of the TV set.

In another embodiment of the method described in the present invention, the decor-appearance chosen from the decor-channel is displaying when the TV set is on a television screen saver mode.

According to our invention, the decor-appearance chosen from the decor-channel is displaying when the TV set is on a television screen saver mode

The above are examples of various embodiments of different variations of the new method to customize a screen appearance of a television (TV) set.

For ease of illustration and as an aid to understanding, in the subsequent description of the illustrative examples, it should be emphasized in the context of the present specification that no particular definition or selection of any specific models or dimensions for a television (TV) set or its screen is required. The above are just a few illustrative examples, according to the present invention, of how the decorative appearance of the television (TV) screen set could be fashioned, used or defined. It is not intended to define or limit the scope of the present invention.

Finally, it should be noted that, while the above-described method to customize a screen appearance of a television (TV) set, other appropriate modifications(s) could equally benefit from this new method to customize a screen appearance of a television (TV) set.

Modifications and improvements to the above-described embodiments of the present invention may become apparent to those skilled in the art. The foregoing description is intended to be illustrative rather than limiting. The scope of the present invention is therefore intended to be limited solely by the scope of the appended claims.

1. A method to customize a screen appearance of a television (TV) set, according to a personal preference of a user, the method comprising:
providing by a TV service provider at least one decor-channel;
presenting at least one decor-appearance into the decor-channel;
offering the decor-channel to the user as a product;
transmitting this at least one decor-channel to at least one TV station, the decor-channel could be transmitted as the product according to a contract between the user and the TV service provider, or as a free of charge;
allowing to the user an opportunity to choose the screen decor-appearance from the decor-channel;
customizing the decor-appearance of the television (TV) set screen according to a personal preference of the user; and
displaying the decor-appearance when TV set is out of use.

2. The method according to claim 1, wherein the décor-channel been included in a portfolio of different channels providing by the TV service provider.

3. The method according to claim 2, wherein the décor-channel being provided as a selected program during activation of the television (TV) set.

4. The method according to claim 3, wherein the décor-channel is including at least one décor-collection, each décor-collection is containing at least two decor-appearances, comprising:
allowing to the user an opportunity to choose the screen décor-appearance from the chosen décor-collection of the décor-channel and to adjust the screen of the TV station with at least one décor-appearance according to the personal preference of the user.

5. The method according to claim 4, wherein the décor-appearances being shifted by the TV service provider or by the user from the same or a different décor-collection.

6. The method according to claim 5, wherein the displayed décor-appearances being shifted in an adjust timeframe.

7. The method according to claim 6, wherein the décor-appearances being produced as at least one slideshow.

8. The method according to claim 7, wherein the décor-appearances on the screen of the television (TV) set are accompanying by a personal preference of a user, such as music, sound, comment, remark, advertisement, news, broadcast, weather announcement, etc, or as any combination of them.

9. The method according to claim 8, wherein the décor-appearances being determined and included/removed by the TV service provider into/of the décor-channel as a result from an identification of a selected décor-appearances, a wish list or a feedback of the user.

10. The method according to claim 9, wherein the décor-appearances being determined and included/removed by the TV service provider into/of the décor-channel as a result of an attitude of the user.

11. The method according to claim 10, wherein the décor-appearances being added or removed by the user or by the TV service provider.

12. The method according to claim 11, wherein the décor-channel is provided with a menu, allowing a selection and search option of décor-appearances.

13. The method according to claim 12, wherein the décor-appearances being displayed as a portion of the screen with an option to be zoomed and/or moved.

14. The method according to claim 13, wherein the portion of the screen being chosen by the user.

15. The method according to claim 14, wherein the décor-appearances being displayed on the portion of the TV screen simultaneously to at least one another program proposed by the TV service provider.

16. The method according to claim 15, wherein the décor-appearances being displayed on the portion of the TV screen simultaneously to another at least one program selected from a television (TV) set menu setup program.

17. The method according to claim 16, wherein the décor-channel being displayed during activation of the TV set.

18. The method according to claim 17, wherein the décor-appearances chosen from the décor-channel being displayed when the TV set is on a television screen saver mode.

19. The method according to claim 18, wherein the décor-appearances chosen from the décor-channel being displayed when the TV set is on a television screen saver mode.
